(19) United States
(12) Patent Application Publication
(10) Pub. No.: US 2026/0130743 A1
(43) Pub. Date: May 14, 2026

(54) SCREW AND DRIVER FOR DENTAL IMPLANT APPLICATIONS

(71) Applicant: Young Innovations, Inc., Algonquin, IL (US)

(72) Inventor: Ines M. Aravena, Santa Rosa Valley, CA (US)

(21) Appl. No.: 19/384,705

(22) Filed: Nov. 10, 2025

Related U.S. Application Data
(60) Provisional application No. 63/718,928, filed on Nov. 11, 2024.

(51) Int. Cl. A61C 8/00

(52) U.S. Cl. CPC A61C 8/0089; A61C 8/0016; A61C 8/0068

(57) ABSTRACT

A dental drive system comprising a driver comprising a coronal end configured to be engaged by a mechanical or electrical mechanisms, an apical end comprising a plurality of complementary engaging features, and a body connecting the coronal end and the apical end and a screw comprising an apical end configured to couple into an abutment or an implant, and a coronal end comprising a plurality of engaging features configured to removably engage with the plurality of complementary engaging features disposed on the apical end of the driver, where the driver is configured to removably engage with the screw at a substantial angle from a vertical axis of the screw to affix the screw into the abutment or the implant.

### CROSS REFERENCE TO RELATED APPLICATIONS

The present application claims the benefit of U.S. Patent Application No. 63/718,928, entitled “SCREW AND DRIVER FOR DENTAL IMPLANT APPLICATIONS” filed on 11 Nov. 2024, which is incorporated herein by reference in its entirety.

### FIELD OF THE INVENTION

The present invention is in the field of dentistry, and, more particularly, is in the field of prosthetic dentistry.

### BACKGROUND

One of the clinical limitations for the construction of a prosthesis to restore masticatory function is having adequate engagement between the driver and the screw to secure the prosthesis into the implant or abutment when angulated screw access channels are required. Several screws and drivers exist in the marketplace to allow for angulated engagement of driver into the screw. Some off-axis drivers have a multi-curving shape with polygonal cross-section to engage a corresponding screw with a polygonal inner feature, such as U.S. Pat. No. 11,382,725 B2. The polygonal engagement typically has a hexagonal shape that offers a small intersection between the driver and the screw engaging features causing the potential premature rounding off the conners of the driver and or damaging of the screw. Other drivers have a substantially spherical configuration with hexalobular shape engaging the screw having a corresponding hexalobular inner feature, such as U.S. Pat. Nos. 10,470,852 B2 and 11,045,288 B2.

Although the hexalobular engagement having six rounded engaging features provides a slightly higher drive strength than the hexagonal drive system, the drawback of the hexalobular drive system is that it offers tangent points of contact to drive the screw and when the driver is tilted away from the axis of the screw some of the contact points may be lost and or premature deformation of the mating features may occur at required fixation torque. The current off-axis drivers in the marketplace having reduced surface contact between the fastening features when driver is at needed angulated position from the main axis of the screw can cause the components to strip prematurely creating delays and extra cost of the procedure. In some cases, users may place the screw access channel within the prosthesis at a non-optimal clinical angle to compensate for the limited angle to fasten the screw at the needed torque to prevent screw loosening. Furthermore, the drivers in the marketplace lack the ability to hold the screw tight during handling to prevent these small components from being swallowed or aspirated by the patient. All these drivers and screws have limitations; and a need exists for a driver having adequate surface engagement with the screw at clinically acceptable angulated access channels.

### SUMMARY

Disclosed herein are approaches for addressing various of the problems and shortcomings of the state of the art, as identified above. More particularly, disclosed herein is a dental drive system for dental implant applications.

According to a first aspect of the present disclosure, there is provided a dental drive system comprising a driver comprising a coronal end configured to be engaged by a mechanical or electrical mechanisms, an apical end comprising a plurality of complementary engaging features, and a body connecting the coronal end and the apical end and a screw comprising an apical end configured to couple into an abutment or an implant, and a coronal end comprising a plurality of engaging features configured to removably engage with the plurality of complementary engaging features disposed on the apical end of the driver, where the driver is configured to removably engage with the screw at a substantial angle from a vertical axis of the screw to affix the screw into the abutment or the implant.

According to a second aspect of the present disclosure, there is provided a dental drive system comprising a driver comprising a coronal end configured to be engaged by a mechanical or electrical mechanisms, an apical end comprising a substantially rounded outer shape comprising plurality of complementary engaging features, wherein each of the plurality of complementary engaging features comprises a pair of curved flat bearing surfaces, and a body connecting the coronal end and the apical end, and a screw comprising an apical end configured to couple into an abutment or an implant, and a coronal end comprising a plurality of engaging features configured to removably engage with the plurality of complementary engaging features disposed on the apical end of the driver, where each of the plurality of engaging features comprises a pair of independent angled flat bearing surfaces and a middle surface configured to interact with each of the plurality of complementary engaging features of the driver and where the driver is configured to removably engage with the screw at a substantial angle from a vertical axis of the screw to affix the screw into the abutment or the implant.

### BRIEF DESCRIPTION OF THE DRAWINGS

FIG. 1 shows a perspective view of an exemplary aspect of a dental drive system.

FIG. 2 shows a perspective view of an exemplary implementation of a screw according to an exemplary aspect of the dental drive system.

FIG. 3A shows a perspective view of an exemplary implementation of a driver according to an exemplary aspect of the dental drive system.

FIG. 3B shows a perspective view of an exemplary implementation of an apical end of an exemplary implantation of the driver according to an exemplary aspect of the dental drive system.

FIG. 4 shows a perspective view of an exemplary aspect of a dental drive system comprising the driver assembled to the screw.

FIG. 5A shows a cross-sectional view of an exemplary engagement of an exemplary implementation of a driver with a screw according to an exemplary aspect of the dental drive system.

FIG. 5B shows a cross-sectional view of an exemplary engagement of an exemplary implementation of a driver with the screw according to an exemplary aspect of a presently available dental drive system.

FIGS. 6A-6C present perspective views of exemplary implementations of the screws with different recess configurations according to an exemplary aspect of the dental drive system.

FIGS. 7A-7C present perspective views of exemplary implementations of the apical ends of drivers comprising different engaging configurations according to an exemplary aspect of the dental drive system.

FIG. 8 presents a cross-sectional view of an exemplary aspect of the dental drive system installed with a dental component, dental implant, and a dental prosthesis.

FIGS. 9A-9B shows cross-sectional views of exemplary implementations of the screw and driver assemblies engaging with a tight fitment as presented in FIG. 8.

FIGS. 10A-10C present cross-sectional views of screws and drivers assembled with off-the-shelf screw and drivers respectively.

### DETAILED DESCRIPTION

The detailed description set forth below is intended as a description of various configurations of the subject technology and is not intended to represent the only configurations in which the subject technology may be practiced. The appended drawings are incorporated herein and constitute a part of the detailed description. The detailed description may include specific details for the purpose of providing a thorough understanding of the subject technology. However, the subject technology is not limited to the specific details set forth herein and may be practiced without these specific details. In some instances, structures and components are shown in block diagram form in order to avoid obscuring the concepts of the subject technology.

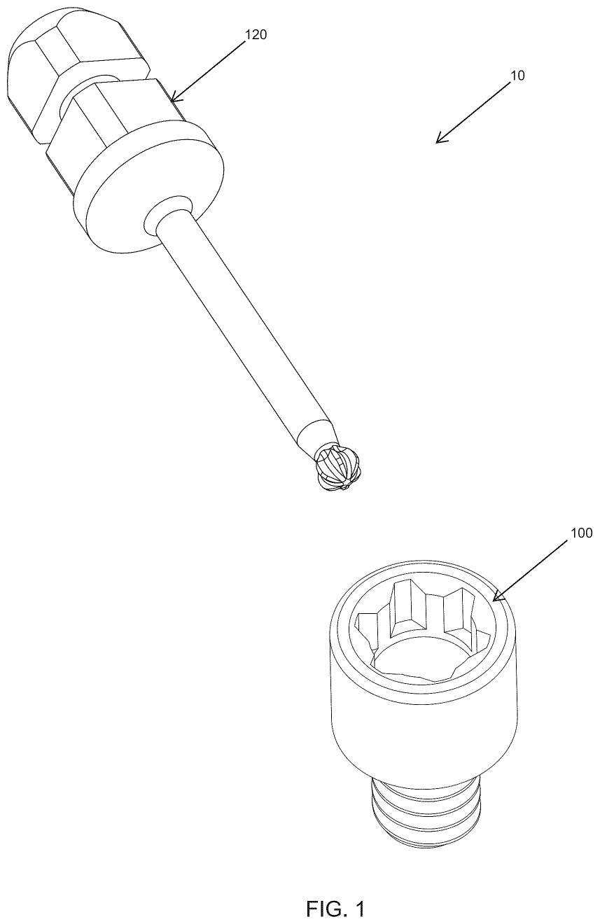

Referring to the drawings, FIG. 1 shows a perspective view of an exemplary aspect of a dental drive system 10. FIG. 1 also presents the primary structural components of the dental drive system 10. These include a screw 100 and a driver 120 configured to engage with the screw 10. The exemplary aspect of the dental drive system presented in FIG. 1 is configured to provide large bearing engaging surfaces between the screw 100 and the driver 120. The large bearing engages surfaces offer improved torsional strength because the transmission of torque is perpendicular to the large surface of the screw 100. This is currently absent in the presently available dental drive systems, which are configured to provide standard point contact radial thrust to expand the head of the screw 100 and dissipate the amount of torque force needed to fasten the screw 100.

Referring to FIG. 2, a perspective view of an exemplary implementation of the screw 100 according to an exemplary aspect of the dental drive system 10 is shown. The exemplary implementation of the screw 100 of FIG. 2 includes an apical end 104 configured to couple into an abutment or implant and a coronal end 106 configured to functionally engage with the driver 120. In this exemplary implementation, the apical end 104 of the screw 100 comprises a threads configured to couple with complementary threads in an implant or an abutment. In some implementations, the apical end 104 can have a snap-fit configuration configure to couple with an implant or an abutment.

In some implementations of the screw 100, the coronal end 106 of the screw 100 can comprise a plurality of engaging features 110 configured to engage with the driver 120 to affix the screw 100 into the implant or abutment. In the implementation of the screw 100 shown in FIG. 2, the coronal end 106 of the screw 100 can comprise the plurality of engaging features 110, each comprising a plurality of flat bearing surfaces 114, 115 configured to engage with the driver 120 for fastening or loosening the screw. In some implementations, such as the implementation of FIG. 2, the plurality of engaging features 110 can be arranged to form a hexalobular shape. In other implementations, the plurality of engaging features 110 can be arranged to form a shape other than a hexalobular shape (e.g., pentalobular shape). In some implementations, the screw 100 can be made of metal (e.g., stainless steel and titanium).

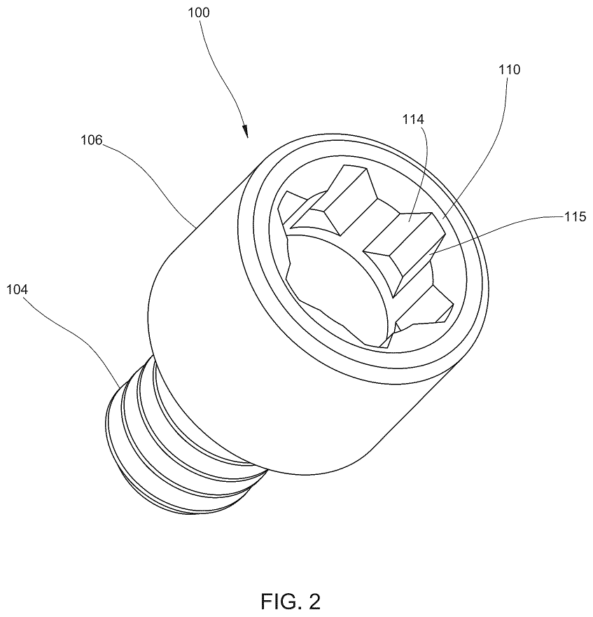

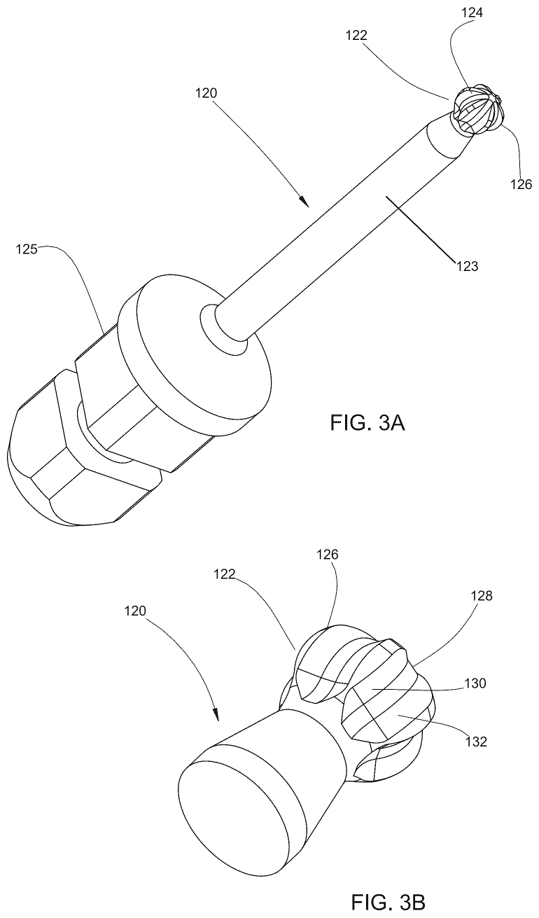

Referring to FIG. 3A, a perspective view of an exemplary implementation of the driver 120 according to an exemplary aspect of the dental drive system 10 is shown. The exemplary implementation of the driver 120 of FIG. 3A includes an apical end 122 configured to engage with the screw 100, a coronal end 125 configured to be engaged by any electric or mechanical mechanisms, and a body 123 connecting the apical end 122 to the coronal end 125. In this implementation, the apical end 122 further comprises a plurality of complementary engaging features 124 disposed on an outer shape 126. In this implementation, the outer shape 126 is substantially rounded. The plurality of complementary engaging features 124 disposed on the outer shape 126 is configured to be complementary to the plurality of engaging features 110 disposed on the coronal end 106 of the screw.

In some implementations, the apical end 22 of the driver 120 can comprise an outer shape different than the substantially rounded outer shape 126 and configured to be a complementary with the coronal end of a screw different than the exemplary implementation of the screw 100 presented in FIG. 2. In some implementations, the body 123 and the apical end 122 of the driver 120 can be made of metal (e.g., stainless steel or titanium) while the coronal end 125 of the driver 120 can be made of a plastic polymer. In some implementations, the coronal end 125 of the driver 120 can further include a plurality of grip features (e.g., protrusions and grooves) to improve traction for better grip when the coronal end 125 is being held by a user.

Referring to FIG. 3B, a perspective view of an exemplary implementation of the apical end 122 of an exemplary implementation of the driver 120 is shown. In this implementation, the outer shape 126 disposed on the apical end 122 where the outer shape 126 is substantially rounded and configured to engage with the coronal end 106 of the screw 100. In this implementation, the plurality of complementary engaging features 124 disposed on the outer shape 126 comprise inner significantly curved cuts 128 with a plurality of flat inner bearing surfaces 130, 132. In some implementations, the plurality of complementary engaging features 124 can further comprise additional features including grooves, threads, notches, and protrusions.

In some aspects of the dental drive system 10, the coronal end 106 of the screw 10 can comprise the substantially rounded outer shape 126 with the plurality of complementary engaging features 124 configured to engage with the plurality of engaging features 110 disposed on the apical end 122 of the driver 120.

Referring to FIG. 4, a perspective view of an exemplary aspect of a dental drive system 10 comprising the driver 120 assembled to the screw 100 at off-axis is presented. In this aspect of the dental drive system, the plurality of the complementary engaging features 124 of the apical end 122 of the driver 120 are configured to be removably engaged with the plurality of engaging features 110 disposed on the coronal head 106 of the screw 100 tilted at a substantial angle 152 from a vertical axis 150 (perpendicular to the coronal head 106 of the screw). In this aspect of the dental drive system 10, the dental drive system 10 is configured to allow for increase torque levels of screw 100 tightening and loosening with the driver 120 even when the screw 100 is tilted at the substantial angle 152 from the vertical axis 150. In some implementations, the substantial angle 152 is selected from a range of angles between 10° to 80°. In other implementations, the substantial angle 152 is selected from a range of angles between 30° to 60°.

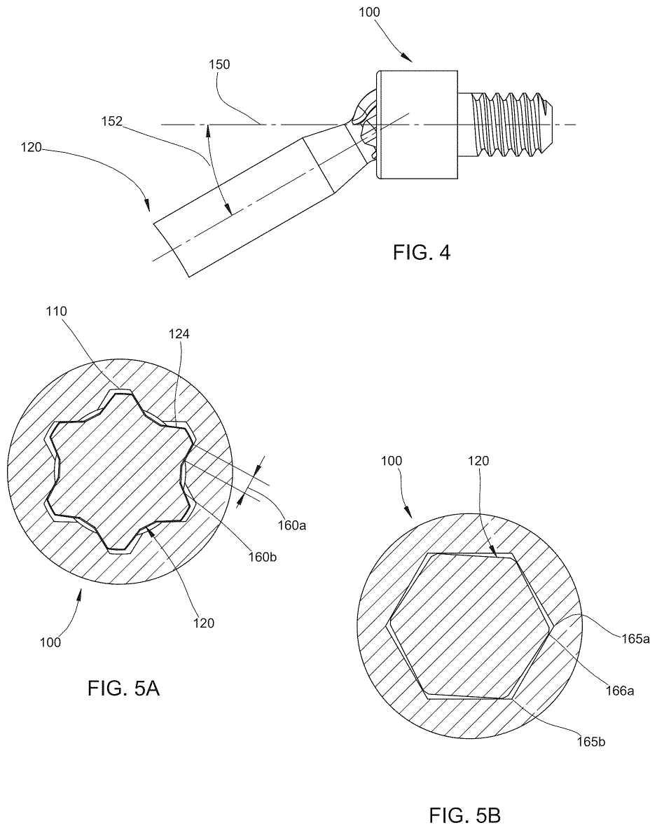

Referring to the figures, FIGS. 5A and 5B show cross-sectional views of exemplary engagement of the driver 120 with the screw 100 in an exemplary implementation of the dental drive system 10 (FIG. 5A) and an off-the-shelf dental drive system (FIG. 5B) respectively.

In the exemplary engagement presented in FIG. 5A, the plurality of the complementary engaging features 124 is removably engaged with the plurality of engaging features 110 (antirotating features) of the screw 100 such that contact surfaces 160 of plurality of complementary engaging features 124 of the driver 120 are engaged with the plurality of flat bearing surfaces 114, 115 (not shown in FIG. 5A). In this implementation, the contact surface 160a of one of the plurality of complementary engaging features 124 is independent and not aligned with the adjacent contact surface 160b allowing a large bearing engaging surface, more efficient anti-rotation, and adequate engagement between the driver 120 and screw 100.

In the exemplary engagement presented in FIG. 5B, the plurality of the complementary contact surfaces 166 is removably engaged with the plurality of engaging features 165 (antirotating features) of an off-the-shelf polygonal screw such that, for example, the complementary contact surface 166a is a point contact bearing surface that is aligned to the adjacent engaging feature 165 resulting in a small bearing engaging surface, less efficient anti-rotation, and inadequate engagement between the driver and screw.

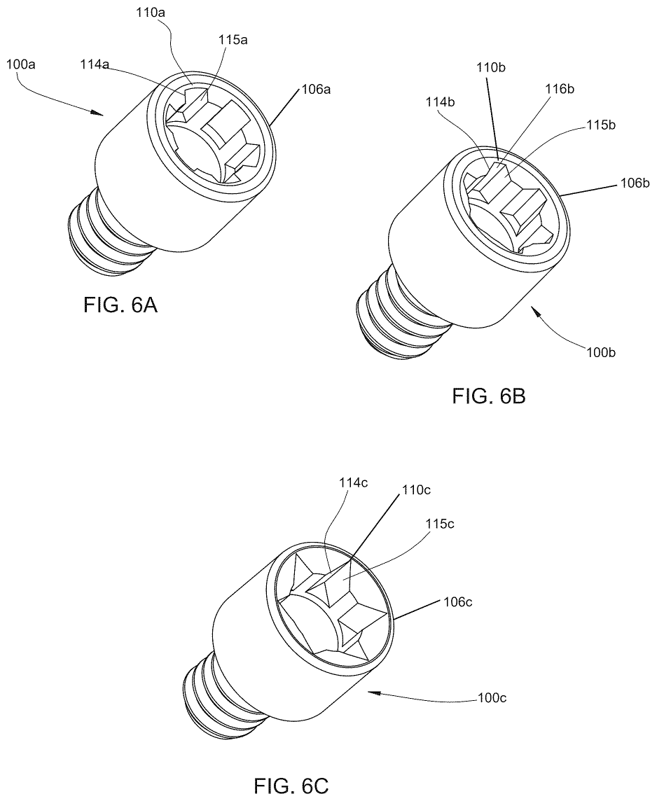

Referring to FIGS. 6A-6C, perspective views of exemplary implementations of the screws (100a-100c) with different recess configurations (antirotating feature) according to an exemplary aspect of the dental drive system 10 are shown.

FIG. 6A presents an exemplary implementation of a screw 100a comprising a plurality of engaging features 110a disposed on the coronal end 106a of the screw 100a, where each of the plurality of engaging features 110a comprises a pair of independent parallel flat bearing surfaces 114a, 115a configured to interact with the plurality of complementary engaging features 124 of the driver 120.

FIG. 6b presents an exemplary implementation of a screw 100b comprising a plurality of engaging features 110b disposed on the coronal end 106b, of the screw 100b where each of the plurality of engaging features 110a comprising a pair of independent angled flat bearing surfaces 114b, 115b and a middle surface 116b configured to interact with the plurality of complementary engaging features 124 of the driver 120.

FIG. 6C presents an exemplary implementation of a screw 100c comprising a plurality of engaging features 110c disposed on the coronal end 106c of the screw 100c, where each of the plurality of engaging features 110a comprises angled flat bearing surfaces 114c, 115c forming a triangular recess (without a middle surface) configured to interact with the plurality of complementary engaging features 124 of the driver 120. In some implementations, the bearing surfaces of the plurality of engaging features 110a-110c of the FIG. 6A-6C can be concave bearing surfaces. In some implementations, the bearing surfaces of the plurality of engaging features 110a-110c of the FIG. 6A-6C can be convex bearing surfaces.

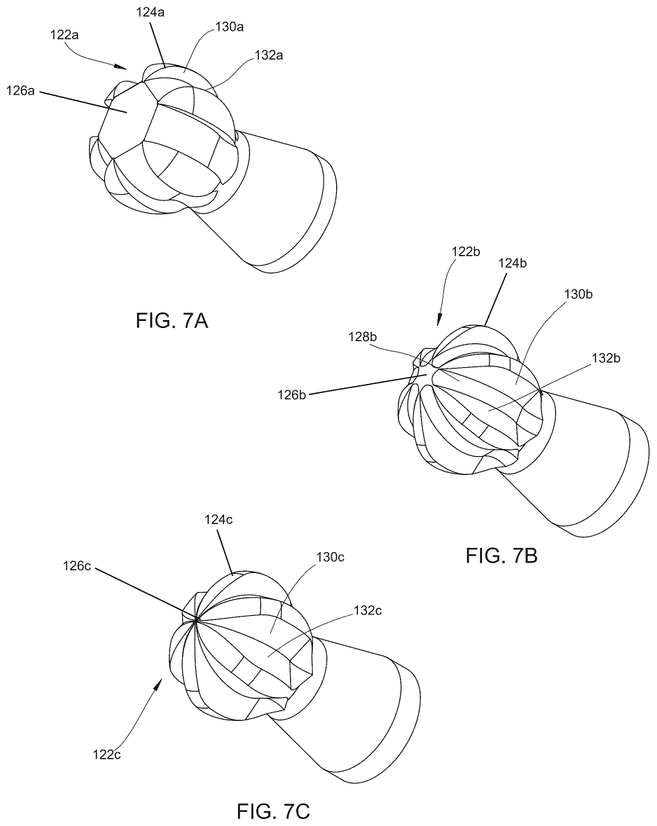

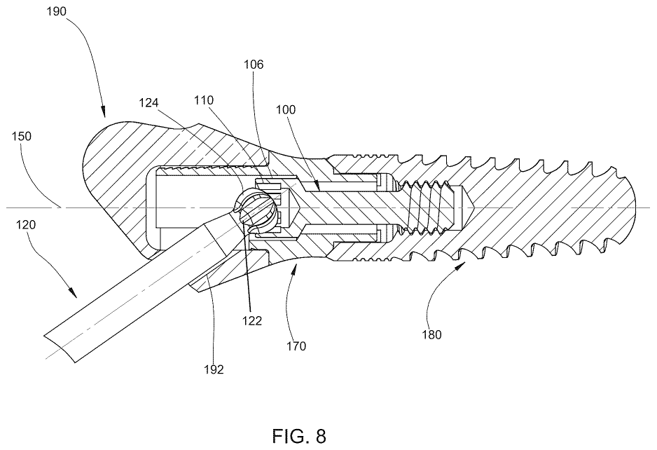

Referring to FIGS. 7A-7C, perspective views of exemplary implementations of the apical ends 126a-126c of drivers 120 comprising different engaging configurations according to an exemplary aspect of the dental drive system 10 are shown.

FIG. 7A presents an exemplary implementation of an apical end 122a of a driver 120 comprising a substantially rounded outer shape 126a configured to engage with the coronal end 106 of the screw 100. In this implementation, the outer shape 126a further comprises a plurality of complementary engaging features 124a, where each of the plurality of complementary engaging features 124a comprises a pair of curved parallel flat bearing surfaces 130a, 132a.

FIG. 7B presents an exemplary implementation of an apical end 122b of a driver 120 comprising a substantially rounded outer shape 126b configured to engage with the coronal end 106 of the screw 100. In this implementation, the outer shape 126b further comprises a plurality of complementary engaging features 124b, where each of the plurality of complementary engaging features 124b comprises a pair of curved angled flat bearing surfaces 130a, 132a and a curved middle surface 128b.

FIG. 7C presents an exemplary implementation of an apical end 122c of a driver 120 comprising a substantially rounded outer shape 126c configured to engage with the coronal end 106 of the screw 100. In this implementation, the outer shape 126c further comprises a plurality of complementary engaging features 124c, where each of the plurality of complementary engaging features 124c comprises a pair of curved angled flat bearing surfaces 130b, 132b (without a curved middle surface). In some implementations, the bearing surfaces of the plurality of complementary engaging features 124a-112c of the FIG. 7A-7C can be concave bearing surfaces. In some implementations, the bearing surfaces of the plurality of complementary engaging features 124a-112c of the FIG. 7A-7C can be convex bearing surfaces.

Referring to the figures, FIG. 8 presents a cross-sectional view of an exemplary aspect of the dental drive system 10 installed with a dental component 170, dental implant 180, and a dental prosthesis 190. In this exemplary aspect, the dental drive system 10 can be used to affix the dental component 170 to the dental implant via the drive 120 and the screw 100. In this aspect, the plurality of engaging features 110 disposed on the coronal end 106 of the screw 100 can be engaged by the plurality of complementary engaging features 124 disposed on the apical end 122 of the driver 120 tilted at the substantial angle 152 (not shown in FIG. 8 and refer to FIG. 4) from the vertical axis 150 (perpendicular to the coronal head 106 of the screw 100). In this aspect of the dental drive system 10, the dental prosthesis 190 affixed onto to the dental component, comprises an angulated access channel 192 configured to provide access to the driver 120 to engage the screw 100 at the substantial angle 152 from the vertical axis 150.

In this aspect, the drive 120 can engage with the screw 100 with a large surface contact area (area of the contact between the plurality of complementary engaging features 124 and the plurality of engaging features 110) such that it requires a screw 100 with a smaller coronal end 106 and a driver 120 with a small apical end 122 and maximizes the torque transfer between the driver 120 and screw 100, extending the life of the components.

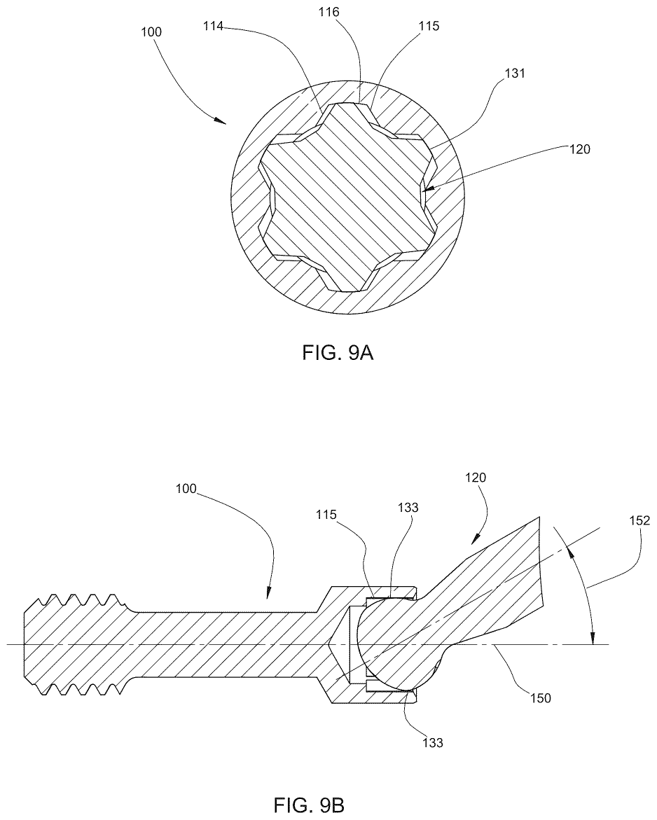

Referring to FIGS. 9A-9B, cross-sectional views of exemplary implementations of the screw 100 and driver 120 assemblies engaging with a tight fitment as presented in FIG. 8 is shown. In this implementation, the screw 100 is a screw 100b presented in FIG. 6B. In this aspect, screw 100 further comprises a plurality of engaging features 110 where each of the plurality of engaging features 110 comprises a pair of angled flat bearing surfaces 114, 115 and a middle surface 116 configured to interact with high points 133 of an outer surface 131 of the plurality of complementary engaging features 124 of the driver 120.

In this implementation, the interaction between the middle surface 116 and the high points 133 of the outer surface 131 of the plurality of complementary engaging features 124 of the driver 120 enables tight fitment between the screw 100 and the driver 120 as well allow the driver 120 to be tilted away from the vertical axis 150 at the substantial angle 152 and still transfer torque from the driver 120 to the screw 100. In some implementations, the screw 100 can be selected from a group comprising screw 100a and screw 100c (presented in FIGS. 6A and 6C above).

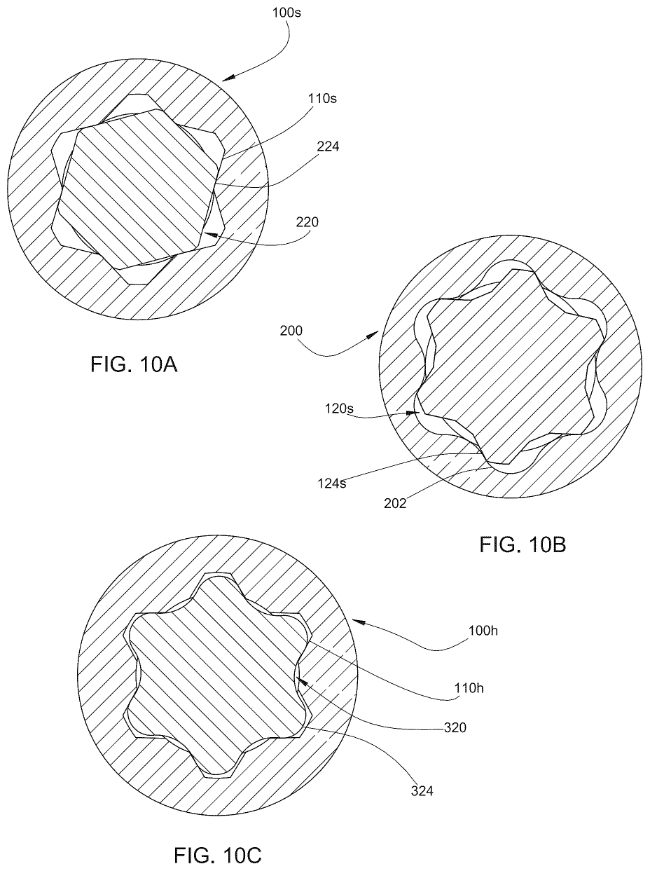

Referring to FIGS. 10A-10C, cross-sectional views of screws 100 and drivers 120 assembled with off-the-shelf screw and drivers respectively. FIG. 10A presents an exemplary implementation of a screw 100s comprising a plurality of engaging features 110s configured to engage with hexagonal feature 224 of an off-the-shelf driver 220. FIG. 10B presents an exemplary implementation of a driver 120s comprising a plurality of complementary engaging surfaces 124s configured to engage with hexalobular features 202 of an off-the-shelf screw 200. FIG. 10C presents an exemplary implementation of a screw 100h comprising a plurality of engaging features 110h configured to engage hexolobular features 324 of an off-the-shelf driver 320.

A reference to an element in the singular is not intended to mean one and only one unless specifically so stated, but rather one or more. For example, “a” module may refer to one or more modules. An element proceeded by “a,” “an,” “the,” or “said” does not, without further constraints, preclude the existence of additional same elements.

Phrases such as an aspect, the aspect, another aspect, some aspects, one or more aspects, an implementation, the implementation, another implementation, some implementations, one or more implementations, an embodiment, the embodiment, another embodiment, some embodiments, one or more embodiments, a configuration, the configuration, another configuration, some configurations, one or more configurations, the subject technology, the disclosure, the present disclosure, other variations thereof and alike are for convenience and do not imply that a disclosure relating to such phrase(s) is essential to the subject technology or that such disclosure applies to all configurations of the subject technology. A disclosure relating to such phrase(s) may apply to all configurations, or one or more configurations. A disclosure relating to such phrase(s) may provide one or more examples. A phrase such as an aspect or some aspects may refer to one or more aspects and vice versa, and this applies similarly to other foregoing phrases.

It is understood that the specific order or hierarchy of steps, operations, or processes disclosed is an illustration of exemplary approaches. Unless explicitly stated otherwise, it is understood that the specific order or hierarchy of steps, operations, or processes may be performed in different order. Some of the steps, operations, or processes may be performed simultaneously. The accompanying method claims, if any, present elements of the various steps, operations or processes in a sample order, and are not meant to be limited to the specific order or hierarchy presented. These may be performed in serial, linearly, in parallel or in different order. It may be understood that the described instructions, operations, and systems can generally be integrated together in a single software/hardware product or packaged into multiple software/hardware products.

The disclosure is provided to enable any person skilled in the art to practice the various aspects described herein. In some instances, well-known structures and components are shown in block diagram form in order to avoid obscuring the concepts of the subject technology. The disclosure provides various examples of the subject technology, and the subject technology is not limited to these examples. Various modifications to these aspects will be readily apparent to those skilled in the art, and the principles described herein may be applied to other aspects.

All structural and functional equivalents to the elements of the various aspects described throughout the disclosure that are known or later come to be known to those of ordinary skill in the art are expressly incorporated herein by reference and are intended to be encompassed by the claims. Moreover, nothing disclosed herein is intended to be dedicated to the public regardless of whether such disclosure is explicitly recited in the claims.

The various illustrative logical blocks, modules, circuits, and algorithm steps described in connection with the embodiments disclosed herein may be implemented as electronic hardware, computer software, or combinations of both. To clearly illustrate this interchangeability of hardware and software, various illustrative components, blocks, modules, circuits, and steps have been described above generally in terms of their functionality. Whether such functionality is implemented as hardware or software depends upon the particular application and design constraints imposed on the overall system. Skilled artisans may implement the described functionality in varying ways for each particular application, but such implementation decisions should not be interpreted as causing a departure from the scope of the present invention.

The hardware used to implement the various illustrative logics, logical blocks, modules, and circuits described in connection with the aspects disclosed herein may be implemented or performed with a general purpose processor, a digital signal processor (DSP), an application specific integrated circuit (ASIC), a field programmable gate array (FPGA) or other programmable logic device, discrete gate or transistor logic, discrete hardware components, or any combination thereof designed to perform the functions described herein. A general-purpose processor may be a microprocessor, but, in the alternative, the processor may be any conventional processor, controller, microcontroller, or state machine. A processor may also be implemented as a combination of computing devices, e.g., a combination of a DSP and a microprocessor, a plurality of microprocessors, one or more microprocessors in conjunction with a DSP core, or any other such configuration. Alternatively, some steps or methods may be performed by circuitry that is specific to a given function.

In one or more exemplary aspects, the functions described may be implemented in hardware, software, firmware, or any combination thereof. If implemented in software, the functions may be stored as one or more instructions or code on a non-transitory computer-readable medium or non-transitory processor-readable medium. The steps of a method or algorithm disclosed herein may be embodied in a processor-executable software module which may reside on a non-transitory computer-readable or processor-readable storage medium. Non-transitory computer-readable or processor-readable storage media may be any storage media that may be accessed by a computer or a processor. By way of example but not limitation, such non-transitory computer-readable or processor-readable media may include RAM, ROM, EEPROM, FLASH memory, CD-ROM or other optical disk storage, magnetic disk storage or other magnetic storage devices, or any other medium that may be used to store desired program code in the form of instructions or data structures and that may be accessed by a computer. Disk and disc, as used herein, includes compact disc (CD), laser disc, optical disc, digital versatile disc (DVD), floppy disk, and Blu-ray disc where disks usually reproduce data magnetically, while discs reproduce data optically with lasers. Combinations of the above are also included within the scope of non-transitory computer-readable and processor-readable media. Additionally, the operations of a method or algorithm may reside as one or any combination or set of codes and/or instructions on a non-transitory processor-readable medium and/or computer-readable medium, which may be incorporated into a computer program product.

The title, background, brief description of the drawings, abstract, and drawings are hereby incorporated into the disclosure and are provided as illustrative examples of the disclosure, not as restrictive descriptions. It is submitted with the understanding that they will not be used to limit the scope or meaning of the claims. In addition, in the detailed description, it can be seen that the description provides illustrative examples and the various features are grouped together in various implementations for the purpose of streamlining the disclosure. The method of disclosure is not to be interpreted as reflecting an intention that the claimed subject matter requires more features than are expressly recited in each claim.

What is claimed is:

1. A dental drive system comprising:
a driver comprising:
a coronal end configured to be engaged by a mechanical or electrical mechanisms;
an apical end comprising a plurality of complementary engaging features; and
a body connecting the coronal end and the apical end; and
a screw comprising:
an apical end configured to couple into an abutment or an implant; and
a coronal end comprising a plurality of engaging features configured to removably engage with the plurality of complementary engaging features disposed on the apical end of the driver,
wherein the driver is configured to removably engage with the screw at a substantial angle from a vertical axis of the screw to affix the screw into the abutment or the implant.

2. The dental drive system of claim 1, wherein the plurality of complementary engaging features is disposed on an outer shape disposed on the apical end of the driver.

3. The dental drive system of claim 2, wherein the outer shape is substantially rounded.

4. The dental drive system of claim 3, wherein each of the plurality of complementary engaging features disposed on the substantially rounded outer shape comprises a pair of curved parallel flat bearing surfaces configured to engage with plurality of the engaging features of the screw.

5. The dental drive system of claim 3, wherein each of the plurality of complementary engaging features disposed on the substantially rounded outer shape comprises a pair of curved angled flat bearing surfaces and a curved middle surface and configured to engage with plurality of the engaging features of the screw.

6. The dental drive system of claim 3, wherein each of the plurality of complementary engaging features disposed on the substantially rounded outer shape comprises a pair of curved angled flat bearing surfaces configured to engage with plurality of the engaging features of the screw.

7. The dental drive system of claim 1, wherein each of the plurality of engaging features of the screw comprises a pair of parallel flat bearing surfaces configured to interact with the plurality of complementary engaging features disposed on the apical end of the driver.

8. The dental drive system of claim 1, wherein each of the plurality of engaging features of the screw comprises a pair of angled flat bearing surfaces and a middle surface configured to interact with the plurality of complementary engaging features disposed on the apical end of the driver.

9. The dental drive system of claim 1, wherein each of the plurality of engaging features of the screw comprises a pair angled flat bearing surfaces forming a triangular recess configured to interact with the plurality of complementary engaging features disposed on the apical end of the driver.

10. The dental drive system of claim 1, wherein the substantial angle is selected from a range of angles between 10° to 80°.

11. The dental drive system of claim 10, wherein the substantial angle is selected from a range of angles between 30° to 60°.

12. The dental drive system of claim 1, wherein the apical end of the screw comprises a plurality of threads configured to removably couple with a plurality of complementary threads in the implant or the abutment.

13. The dental drive system of claim 1, wherein the body and the apical end of the driver and the screw is made of metal.

14. The dental drive system of claim 13, where the metal is selected from a group of metal comprising stainless steel and titanium.

15. The dental drive system of claim 1, wherein the coronal end of the drive is made of a plastic polymer.

16. A dental drive system comprising:
a driver comprising:
a coronal end configured to be engaged by a mechanical or electrical mechanisms;
an apical end comprising a substantially rounded outer shape comprising plurality of complementary engaging features,
wherein each of the plurality of complementary engaging features comprises a pair of curved flat bearing surfaces; and
a body connecting the coronal end and the apical end; and
a screw comprising:
an apical end configured to couple into an abutment or an implant; and
a coronal end comprising a plurality of engaging features configured to removably engage with the plurality of complementary engaging features disposed on the apical end of the driver,
wherein each of the plurality of engaging features comprises a pair of independent angled flat bearing surfaces and a middle surface configured to interact with each of the plurality of complementary engaging features of the driver,
wherein the driver is configured to removably engage with the screw at a substantial angle from a vertical axis of the screw to affix the screw into the abutment or the implant.
